(19) United States
(12) Patent Application Publication
(10) Pub. No.: US 2011/0032704 A1
(43) Pub. Date: Feb. 10, 2011

(54) LIGHTING DISPLAY APPARATUS AND THE METHOD FOR MANUFACTURING THE SAME

(76) Inventors: Sang Keun Oh, Seongnam-si (KR); Do Hyeong Park, Gwangju-si (KR); Yeo Hwan Yoon, Seoul (KR)

Correspondence Address: KED & ASSOCIATES, LLP, P.O. Box 8638, Reston, VA, 20195, US

(21) Appl. No.: 12/936,629

(22) PCT Filed: Jan. 15, 2009
(86) PCT No.: PCT/KR09/00212

§ 371 Date: Oct. 6, 2010

(30) Foreign Application Priority Data
Apr. 8, 2008 (KR) 10-2008-0032717
Jul. 11, 2008 (KR) 10-2008-0067593

(51) Int. Cl. F21V 21/00; H01J 9/00

(52) U.S. Cl. 362/249.14; 445/24

(57) ABSTRACT

Provided is a light-emitting display and a method of fabricating the same. The light-emitting display includes a base substrate, and at least one unit light-emitting layer disposed on an upper surface of the base substrate. Here, the unit light-emitting layer includes an electrode pattern layer having a plurality of electrode patterns formed in a specific pattern, at least one light-emitting device connected with the electrode patterns of the electrode pattern layer and selectively emitting light, and an electrode protection layer disposed to cover the electrode pattern layer.

### TECHNICAL FIELD

The present invention relates to a light-emitting display and a method of fabricating the same, and more particularly, to a light-emitting display that can be applied to various fields such as lighting, indoor and outdoor billboards, outdoor electric bulletin boards, fancy products and vehicles, and a method of fabricating the light-emitting display.

### BACKGROUND ART

Large light-emitting displays are used in indoor and outdoor electric bulletin boards and advertising boards, and small light-emitting displays are used to display numbers or simple figures.

In general, light-emitting displays have a light-emitting diode (LED) as a light source, and are fabricated by the following conventional method. First, a metal pattern is formed on the upper surface of a bottom substrate, and LEDs are connected with the metal pattern. The bottom substrate is attached to a top substrate made of a transparent material using a sealant, etc. Subsequently, a space between the attached top and bottom substrates is filled with a filler. The filler is generally composed of a hardening material. Thus, the space is filled with a liquid hardening material, and then the liquid hardening material is hardened. The filler functions to fix and protect LEDs and to prevent an external light-transmitting plate from sinking.

However, the method of fabricating a light-emitting display additionally requires a step of injecting a liquid hardening material between the external light-transmitting plate and the bottom substrate, and a step of hardening the liquid hardening material.

More specifically, a passage for hardening material must be formed in the bottom substrate or the top substrate to inject the liquid hardening material, and the passage must be closed after being completely filled with the liquid hardening material. In addition, to harden the liquid hardening material, ultraviolet (UV) rays must be radiated onto the light-emitting display. Thus, the process of fabricating the light-emitting display is complicated and productivity deteriorates.

In addition, the liquid hardening material is injected and hardened after the top and bottom substrates are sealed off. Thus, it is impossible to form a plurality of electrode pattern layers. To solve this problem, a plurality of LEDs having different colors may be disposed adjacent to each other, but electrode patterns are disposed in a single layer in a conventional light-emitting display. Thus, when a plurality of LEDs are disposed adjacent to each other, electrode patterns are very complicated, and high voltage is required to drive the LEDs. For this reason, LEDs cannot be variously disposed, and thus the light-emitting display cannot display various figures and colors.

Furthermore, in the conventional light-emitting display fabricated as described above, bubbles rise from the hardened UV-hardening material. In general, an adhesive member for fixing LEDs is composed of epoxy adhesive or silver paste. In the process of injecting the UV-hardening material, a component of the adhesive member may react to an acid component of the UV-hardening material, and thus gas, etc., that is, the bubbles, may be generated. The bubbles may also be generated while the UV-hardening material seeps into the LEDs.

Such bubbles cause various problems. For example, light radiated onto the top substrate is distorted, the transparency of the light-emitting display decreases, and a strength to fix the LEDs or an ability to protect the LEDs deteriorates.

### DISCLOSURE OF INVENTION

### Technical Problem

The present invention is directed to providing a light-emitting display that protects electrode patterns without using a filler, and a method of fabricating the light-emitting display.

The present invention is also directed to providing a light-emitting display in which bubbles are not generated from a space between a top substrate and a bottom substrate, and a method of fabricating the light-emitting display.

The present invention is also directed to providing a light-emitting display that displays various figures and colors while having simple electrode patterns, and that can operate at low voltage, and a method of fabricating the light-emitting display.

### Technical Solution

One aspect of the present invention provides a light-emitting display including: a base substrate; and at least one unit light-emitting layer disposed on an upper surface of the base substrate. The unit light-emitting layer may be attached to an external light-transmitting plate.

The unit light-emitting layer may include an electrode pattern layer, at least one light-emitting device and an electrode protection layer. The electrode pattern layer may include a plurality of electrode patterns formed in a specific pattern. The light-emitting device may be connected with the electrode patterns of the electrode pattern layer and selectively emitting light. The electrode protection layer may be formed of transparent polymer foam, and may be disposed to cover the electrode pattern layer.

The polymer foam forming the electrode protection layer may be urethane foam or acryl foam.

The light-emitting display may further comprise at least one unit light-emitting layer stacked on a lower surface of the base substrate.

Another aspect of the present invention provides a light-emitting display including: a base substrate; and a plurality of unit light-emitting layers stacked on an upper surface of the base substrate and emitting light upward. The unit light-emitting layers may include: an electrode pattern layer having a plurality of electrode patterns formed in a specific pattern; at least one light-emitting device connected with the electrode patterns of the electrode pattern layer and selectively emitting light; and an electrode protection layer disposed to cover the electrode pattern layer.

Still another aspect of the present invention provides a light-emitting display including: an electrode pattern layer having a plurality of electrode patterns formed in a specific pattern in upper and lower surfaces; at least one first light-emitting device connected with an electrode pattern formed in the upper surface of the electrode pattern layer and selectively emitting light upward; at least one second light-emitting device connected with an electrode pattern formed in the lower surface of the electrode pattern layer and selectively emitting light downward; and electrode protection layers disposed to cover the upper and lower surfaces of the electrode pattern layer.

Yet another aspect of the present invention provides a light-emitting display including: a base layer; at least one first unit light-emitting layer stacked on an upper surface of the base layer and emitting light upward; and at least one second unit light-emitting layer stacked on a lower surface of the base layer and emitting light downward. The first and second unit light-emitting layers may include: an electrode pattern layer having a plurality of electrode patterns formed in a specific pattern; at least one light-emitting device connected with the electrode patterns of the electrode pattern layer and selectively emitting light; and an electrode protection layer disposed to cover the electrode pattern layer.

Yet another aspect of the present invention provides a method of fabricating a light-emitting display including: providing a base substrate including an electrode pattern layer having electrode patterns and at least one light-emitting device formed on its upper surface; adhering an upper surface of the electrode pattern layer including at least the light-emitting device to a lower surface of a filler; providing an external light-transmitting plate; and adhering a lower surface of the external light-transmitting plate to the filler.

Yet another aspect of the present invention provides a method of fabricating a light-emitting display including: preparing a base substrate; stacking at least one unit light-emitting layer including an electrode pattern layer having a plurality of electrode patterns, at least one light-emitting device connecting the electrode patterns and an electrode protection layer formed of transparent polymer foam and sealing at least the light-emitting device on the electrode pattern layer, on an upper surface of the base substrate; and adhering an external light-transmitting plate to the electrode protection layer of a finally stacked unit light-emitting layer.

The method may further include stacking at least one of the unit light-emitting layer on a lower surface of the base substrate.

### Advantageous Effects

A light-emitting display according to an exemplary embodiment of the present invention displays several colors and figures while having simple electrode patterns. Thus, the light-emitting display operates at low voltage and reduces power consumption. Also, electrode patterns are simply designed and production cost can be reduced.

In addition, a motion picture can be displayed using light-emitting devices densely disposed in layers. According to the arrangement of light-emitting devices, specific letters can be alternately displayed or flickered, and a specific logo also can be displayed.

Furthermore, according to the inventive light-emitting display and method of fabricating the same, a filler layer does not need to be interposed between attached substrates. Thus, a plurality of electrode pattern layers can be formed, and bubbles are not generated between the attached substrates.

### BRIEF DESCRIPTION OF DRAWINGS

FIG. 1 is a flowchart showing a method of fabricating a light-emitting display according to an exemplary embodiment of the present invention;

FIGS. 2 to 5 are cross-sectional views illustrating respective steps of fabricating a light-emitting display according to a first exemplary embodiment of the present invention;

FIG. 2 is a cross-sectional view illustrating a step of providing a base substrate;

FIG. 3 is a cross-sectional view illustrating a step of adhering an electrode protection layer to an upper surface of the base substrate;

FIG. 4 is a cross-sectional view illustrating a step of providing an external light-transmitting plate;

FIG. 5 is a cross-sectional view illustrating a step of adhering the external light-transmitting plate to the electrode protection layer;

FIGS. 6 and 8 are cross-sectional views illustrating respective steps of fabricating a light-emitting display according to a second exemplary embodiment of the present invention;

FIG. 6 is a cross-sectional view illustrating a step of forming a first unit light-emitting layer on a base substrate;

FIG. 7 is a cross-sectional view illustrating a step of stacking a second unit light-emitting layer on the first unit light-emitting layer;

FIG. 8 is a cross-sectional view illustrating a step of adhering an external light-transmitting plate to the second unit light-emitting layer;

FIG. 9 is a cross-sectional view of a light-emitting display according to a third exemplary embodiment of the present invention;

FIG. 10 is a front view of one of light-emitting displays according to exemplary embodiments of the present invention;

FIGS. 11 and 12 are cross-sectional views of a light-emitting display according to a fourth exemplary embodiment of the present invention;

FIG. 13 is a cross-sectional view of a light-emitting display according to a fifth exemplary embodiment of the present invention; and

FIGS. 14 and 15 are diagrams illustrating an example of operation of a light-emitting display according to an exemplary embodiment of the present invention.

### MODE FOR THE INVENTION

Hereinafter, exemplary embodiments of the present invention will be described in detail. However, the present invention is not limited to the exemplary embodiments disclosed below and can be implemented in various modified forms. The exemplary embodiments are described to fully enable those of ordinary skill in the art to embody and practice the present invention.

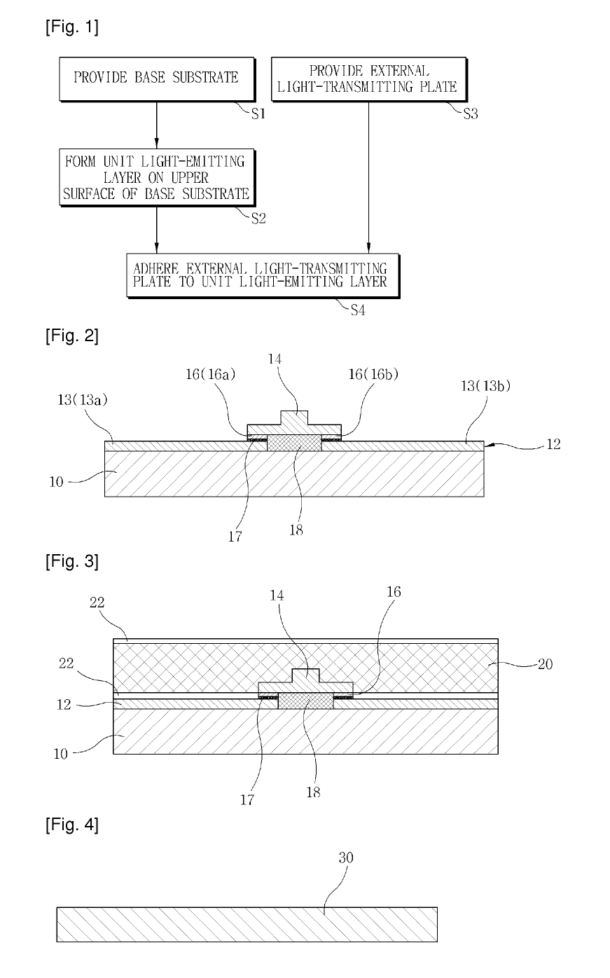

FIG. 1 is a flowchart showing a method of fabricating a light-emitting display according to an exemplary embodiment of the present invention.

As illustrated in FIG. 1, the method of fabricating a light-emitting display according to an exemplary embodiment of the present invention includes a step of providing a base substrate (S1) and a step of forming at least one unit light-emitting layer on the upper surface of the base substrate (S2). In addition to these steps, the method may include a step of providing an external light-transmitting plate (S3) and a step of adhering the lower surface of the external light-transmitting plate to the upper surface of the unit light-emitting layer (S4).

The unit light-emitting layer includes an electrode pattern layer formed on a specific member surface, at least one light-emitting device connecting electrode patterns of the electrode pattern layer and selectively emitting light, and an electrode protection layer formed to cover at least a surface of the electrode pattern layer on which the light-emitting device is disposed. Here, the electrode protection layer may be formed of transparent polymer foam.

FIGS. 2 to 5 are cross-sectional views illustrating respective steps of fabricating a light-emitting display according to a first exemplary embodiment of the present invention.

First, as illustrated in FIG. 2, a base substrate 10 is provided. Here, an electrode pattern layer 12 and light-emitting devices 14 may be installed on the upper surface of the base substrate 10.

The electrode pattern layer 12 and light-emitting devices 14 may be installed on the upper surface of the base substrate 10. In order to form the light-emitting devices 14 on the upper surface of the base substrate 10, a plurality of electrode patterns 13 may be formed on the upper surface of the base substrate 10, and then the light-emitting devices 14 may connect the electrode patterns 13. Although not shown in the drawings, the ends of the electrode patterns 13 may be connected with positive and negative power supplies.

A layer in which the electrode patterns 13 are formed is the electrode pattern layer 12. The electrode pattern layer 12 may include the electrode patterns 13 alone, or the electrode patterns 13 formed on a polymer film of polyethylene terephthalate (PET), tricresyl phosphate (TCP), etc.

However, the present invention is not limited to these structures. An electrode protection layer to be described below may be adhered to the upper surface of the base substrate 10, and then the electrode pattern layer 12 and the light-emitting device 14 may be disposed on the upper surface of the electrode protection layer.

The electrode patterns 13 constituting the electrode pattern layer 12 may be formed of a conductive metal such as indium tin oxide (ITO), carbon nanotubes (CNTs), or a conductive polymer. In addition, the electrode patterns 13 constituting the electrode pattern layer 12 may be line electrode patterns having a linear shape, or surface electrode patterns having a planar shape.

Subsequently, the light-emitting devices 14 are adhered to previously determined positions on the upper surface of the base substrate 10, for example, between the electrode patterns 13 disposed apart from each other. The light-emitting devices 14 may be any light-emitting devices capable of emitting light such as light emitting diodes (LEDs), laser diodes, organic light-emitting diodes (OLEDs), and field emission devices (FEDs). In addition, the light-emitting devices 14 adjacent to the base substrate 10 may be formed to protrude from the surface of the base substrate 10, or may be installed in a groove formed in the base substrate 10.

When an LED is used as an example of the light-emitting device 14, a first electrode 16a of the LED 14 may be connected to a first electrode pattern 13a, and a second electrode 16b of the LED 14 may be connected to a second electrode pattern 13b spaced apart from the first electrode pattern 13a. Therefore, when the electrodes 16a and 16b of the LED connect the first electrode pattern 13a with the second electrode pattern 13b, and electrical signals are supplied from a positive power supply and a negative power supply to the first electrode pattern 13a and the second electrode pattern 13b respectively, the LED emits light.

The electrodes of the light-emitting device 14 may be adhered to the electrode patterns 13 by a conductive adhesive 17. The conductive adhesive 17 may be epoxy adhesive or silver paste. Here, a support member 18 that firmly supports the light-emitting device 14 on the base substrate 10 may be formed between adjacent electrode patterns 13.

Subsequently, an electrode protection layer 20 is adhered to the upper surface of the electrode pattern layer 12, as illustrated in FIG. 3.

The electrode protection layer 20 is mainly formed of transparent polymer foam. The transparent polymer foam is not a liquid hardening material and thus does not require a hardening step. In addition, the transparent polymer foam does not chemically react to either of the light-emitting device 14 and the conductive adhesive 17 that adheres the light-emitting device 14 to the electrode patterns 13. Thus, no bubbles are generated in the electrode protection layer 20. Furthermore, the polymer foam is a foam material and thus can excellently fix and protect light-emitting devices.

The transparent polymer foam may be acryl foam or urethane foam. The acryl foam and urethane foam have excellent transparency and can be adhered to a light-emitting device without a gap due to excellent foaming ability.

Between the transparent polymer foam and the electrode pattern layer 12, an adhesive member for adhering them to each other may be interposed.

As an example of the adhesive member, a double-sided adhesive tape may be adhered to at least one surface of the transparent polymer foam. Thus, the transparent polymer foam to which the adhesive member is attached may be a polymer foam tape such as an acryl foam tape and a urethane foam tape. In the case of the polymer foam tape, an external light-transmitting plate to be described below is easily and quickly adhered to the base substrate 10.

As illustrated in FIG. 4, an external light-transmitting plate 30 may be disposed on the upper surface of the electrode protection layer 20. The external light-transmitting plate 30 may be a protection film. When the external light-transmitting plate 30 is a protection film, the electrode protection layer 20 with the protection film removed can be directly adhered to the corresponding surface such as a display window.

The external light-transmitting plate may be formed of tempered glass so as to be highly resistant to external impact. Alternatively, the external light-transmitting plate may be formed of common glass, transparent polymer, frit glass, etc.

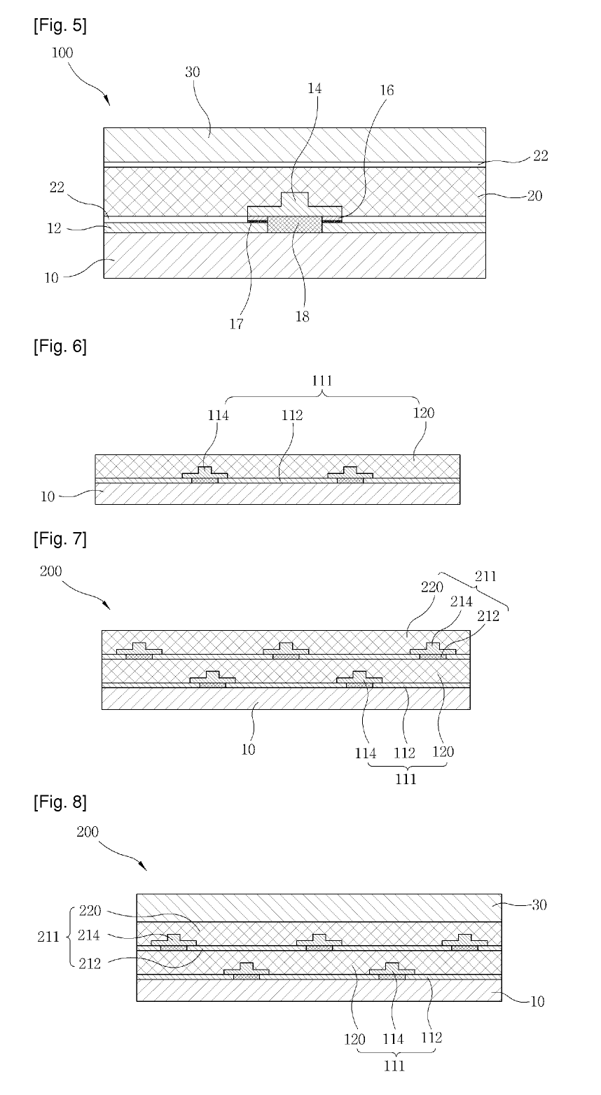

Subsequently, as illustrated in FIG. 5, the external light-transmitting plate 30 is attached to the electrode protection layer 20. A sealant (not shown) may be applied to the upper surface of the base substrate 10 or the lower surface of the external light-transmitting plate 30 such that the base substrate 10 and the external light-transmitting plate 30 can be attached to each other by the sealant. Alternatively, an exemplary embodiment of the present invention may not use sealant. In this case, the electrode protection layer 20 may be a transparent polymer foam tape. Thus, the external light-transmitting plate 30 and the electrode protection layer 20 are firmly attached to each other and sealant is not needed.

According to an exemplary embodiment of the present invention, a light-emitting display is simply fabricated, and no bubbles are generated in an electrode protection layer because there is no chemical reaction between the electrode protection layer and a light-emitting device and between the electrode protection layer and a light-emitting device adhesive. Also, it is possible to obtain better transparency than a conventional method.

In addition, according to an exemplary embodiment of the present invention, a gap between an external light-emitting plate and a base substrate does not need to be sealed to form the electrode protection layer, and the electrode protection layer can be formed at normal temperature. Thus, an electrode pattern layer can be formed on or attached to the surface of the transparent polymer foam, such that various electrode patterns can be formed by stacking a plurality of electrode pattern layers and light-emitting devices. In this case, as described above, the electrode pattern layer including electrode patterns alone may be formed on the surface of the transparent polymer foam, or electrode patterns of the electrode pattern layer may be formed on a polymer film of PET, TCP, etc., attached to the surface of the electrode pattern layer.

The electrode pattern layer formed on the upper surface of the electrode protection layer may have excellent flexibility, and thus may be formed of CNTs or a conductive polymer.

As illustrated in FIGS. 6 to 8, assuming that an electrode pattern layer, light-emitting devices, and an electrode protection layer constitute one unit light-emitting layer, a plurality of the unit light-emitting layers can be stacked on a base substrate.

To form, for example, double unit light-emitting layers, a first unit light-emitting layer 111, which includes a first electrode pattern layer 112, first light-emitting devices 114 and a first electrode protection layer 120, is formed on a base substrate 10 as illustrated in FIG. 6.

Subsequently, as illustrated in FIG. 7, a second unit light-emitting layer 211 is formed on the upper surface of the first unit light-emitting layer 111. More specifically, a second electrode pattern layer 212 may be formed on the upper surface of the first electrode protection layer 120, second light-emitting devices 214 connecting electrode patterns constituting the second electrode pattern layer 212 may be installed, and then the upper surface of the second electrode pattern layer 212 may be covered by a second electrode protection layer 220 formed of transparent polymer foam.

Subsequently, as illustrated in FIG. 8, an external light-transmitting plate 30 is attached to the second electrode protection layer 220.

Here, at least the first and second electrode protection layers 120 and 220 may be transparent polymer foam tapes and can be adhered to the second electrode pattern layer 212 and the external light-transmitting plate 30, respectively.

FIGS. 6 to 8 illustrate a process of forming double unit light-emitting layers between an external light-transmitting plate and a base substrate. However, the present invention is not limited to double unit light-emitting layers, and three or more unit light-emitting layers also can be formed.

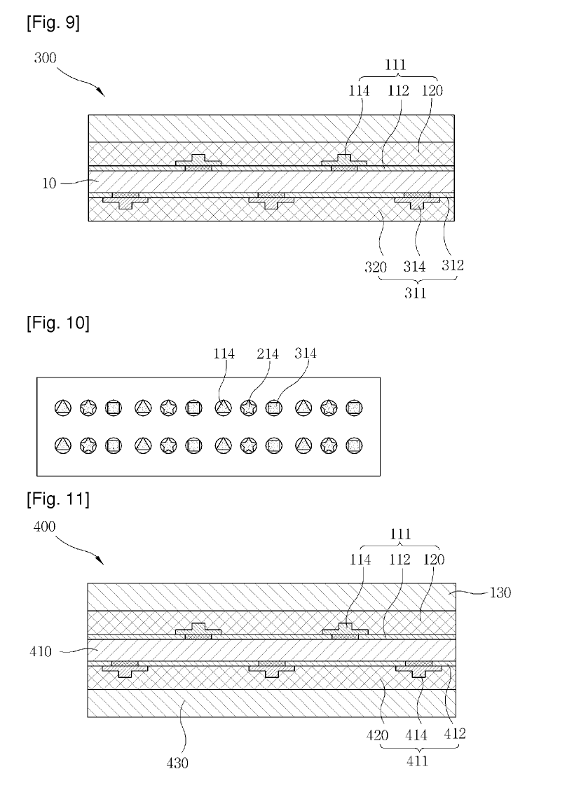

In addition, the unit light-emitting layer does not need to be formed only between the external light-transmitting plate 30 and the base substrate 10. As illustrated in FIG. 9, at least one unit light-emitting layer 311 may be formed on the lower surface of the base substrate 10. In other words, a third electrode pattern layer 312, a third light-emitting device 314 and a third electrode protection layer 320 can be formed in sequence on the lower surface of the base substrate 10. This is because, as described above, transparent polymer foam is simply adhered to form an electrode protection layer without sealing a gap between two substrates, unlike a conventional method.

By installing light-emitting devices in a plurality of layers, first light-emitting devices 114, second light-emitting devices 214, third light-emitting devices 314, etc., of respective layers can be variously arranged to display a variety of figures and colors. Thus, a light-emitting display can emit light in a variety of figures and colors.

As light-emitting displays fabricated using the above-described method, light-emitting displays according to exemplary embodiments of the present invention will be described below.

FIG. 5 is a cross-sectional view of a light-emitting display 100 according to a first exemplary embodiment of the present invention. As illustrated in FIG. 5, the light-emitting display 100 according to a first exemplary embodiment of the present invention includes an external light-transmitting plate 30, a base substrate 10, and a unit light-emitting layer. Here, the unit light-emitting layer includes an electrode pattern layer 12, a light-emitting device 14, and an electrode protection layer 20.

The base substrate 10 may be formed of various materials such as a flexible polymer and glass.

The electrode pattern layer 12 is formed on at least one of the base substrate 10 and the external light-transmitting plate 30. The electrode pattern layer 12 may include electrode patterns alone, or electrode patterns of the electrode pattern layer 12 may be formed on a polymer film of PET, TCP, etc.

The electrode patterns included in the electrode pattern layer 12 may be formed by patterning a conductive metal through etching, etc., or may be formed of a conductive polymer.

The electrode patterns constituting the electrode pattern layer 12 may be formed of CNTs. CNTs have better flexibility than conductive metals, and thus it is possible to prevent an electrode from breaking while a light-emitting display is fabricated or used. In addition, CNTs can be precisely patterned with a precision of several micrometers or less, and CNT electrode patterns can be formed in a large area. Furthermore, it is possible to overcome the conventional limitations of electrode design caused when an ITO thin film is processed by a laser to implement a complex image.

The electrode patterns are finely patterned to a width of 1 nm to 100 μm so as not to be easily seen, or fabricated to a thickness of 1 nm to 1 μm so as to have transparency.

When the width or thickness of the electrode patterns is less than 1 nm, networks between CNTs are not properly formed. Then, resistance increases or current cannot be properly delivered. On the other hand, when the width of the electrode patterns is greater than 100 μm and the thickness is greater than 1 μm, transparency of the electrode patterns decreases and the electrode patterns are easily noticed.

Transparency can be increased not only by adjusting the line width but also by reducing the thickness of a coated conductive material. The transparency and thickness of a coated material are inversely proportional to each other, and transparency is directly proportional to surface resistance. Thus, these factors must be appropriately selected for the conditions of a transparent display in consideration of desired transparency and resistance.

The CNTs have a diameter of several nanometers and a length of several hundred to several thousand nanometers. The CNTs may be one selected from the group of single-walled CNTs, double-walled CNTs and multi-walled CNTs.

In addition, a conductive metal may be attached to the surfaces of the CNTs. The conductive metal may be one selected from the group of Au, Ag, Cu, Fe, Al, Cr, Ti, Pt, Pd, and any combination thereof.

On the other hand, the electrode patterns may be formed of a polymer. The electrode patterns have a plurality of conductive parts and a plurality of non-conductive parts. The conductive parts are disposed apart from each other around a specific pattern region, and the non-conductive parts are formed in the specific pattern region. The conductive parts and the non-conductive parts may be formed as one body.

The electrode patterns are formed of a polymer and thus have excellent flexibility. In addition, since the conductive parts and the non-conductive parts can be formed as one body, light-emitting devices can be stably disposed on the electrode patterns, the light-emitting display does not appear speckled from outside, and the solidity of the light-emitting display also increases.

The polymer constituting the conductive parts and the non-conductive parts has conductivity, and the non-conductive parts may be obtained by inactivating the conductivity of the polymer.

The conductive polymer has excellent flexibility. Thus, the light-emitting display having the conductive polymer is not broken even if it bends. In addition, the light-emitting display having the conductive polymer is lightweight, priced lower than metal, and has a small thickness.

Meanwhile, the conductive polymer generally has a high sheet resistance of 100 ohms/sq or more. To solve this problem, the conductive polymer needs to be used as a surface electrode. More specifically, a specific patterned part is formed of a conductive polymer, and the conductive polymer is electrically connected with a cathode or anode so as to be used as an electrode.

The light-emitting device 14 is connected with the electrode patterns 13 and selectively emits light. The light-emitting device 14 may be any light-emitting device capable of emitting light such as an LED, a laser diode, an organic light-emitting diode OLED, and an FED.

The electrode protection layer 20 is interposed between the base substrate 10 and the external light-transmitting plate 30, and is formed of transparent polymer foam. A filler constituting the electrode protection layer 20 may be urethane foam or acryl foam.

In addition, a double-sided adhesive tape 22 may be interposed between the polymer foam and the external light-transmitting plate 30 and between the polymer foam and the base substrate 10. Due to the double-sided adhesive tapes 22, the electrode protection layer 20 can be firmly and simply adhered to the external light-transmitting plate 30 and the base substrate 10.

An adhesive member is disposed between the transparent polymer foam and the external light-transmitting plate 30 to adhere them to each other. An example of the transparent polymer foam and the adhesive member may be a polymer foam tape.

FIG. 7 is a cross-sectional view of a light-emitting display 200 according to a second exemplary embodiment of the present invention. As illustrated in FIG. 7, the light-emitting display 200 may be formed by stacking a plurality of unit light-emitting layers 111 and 211, etc., on the base substrate 10. As illustrated in FIG. 8, the external light-transmitting plate 30 may be adhered to the uppermost unit light-emitting layer 211. Thus, when the shapes of electrode patterns and the colors, shapes and positions of light-emitting devices in the unit light-emitting layer 111 are different from those in the unit light-emitting layer 211, various figures and colors can be displayed.

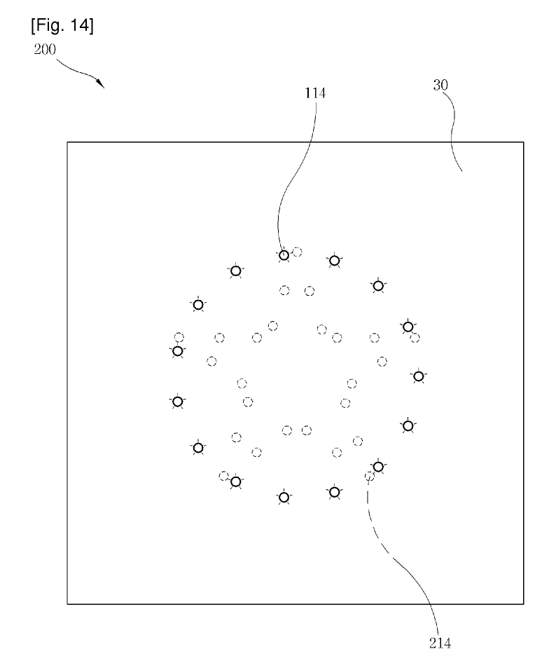

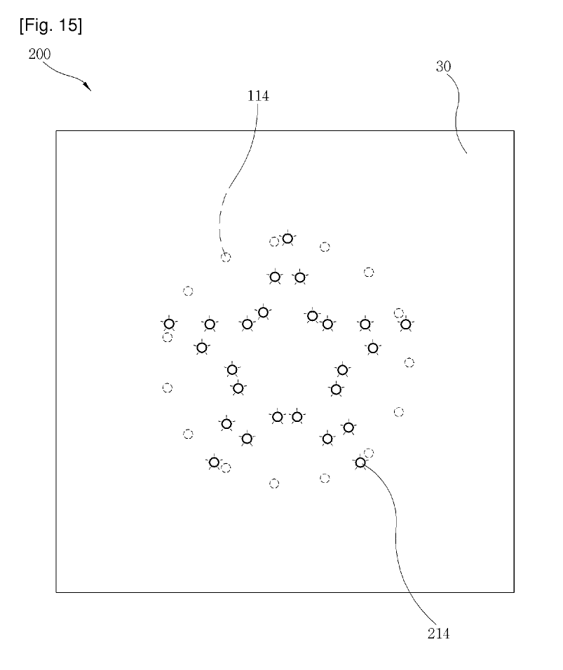

FIGS. 14 and 15 are diagrams illustrating operation of the light-emitting display 200 shown in FIG. 8.

As illustrated in FIG. 14, in the light-emitting display 200 according to the second exemplary embodiment of the present invention, light-emitting devices 114 disposed along a circle are turned on and light-emitting devices 214 disposed in the shape of a star are turned off. And, as illustrated in FIG. 15, the light-emitting devices 114 disposed along a circle are turned off and the light-emitting devices 214 disposed in the shape of a star are turned on, such that a user can alternately see the star and the circle. In other words, several figures can be displayed by one light-emitting display 200. Here, three or more unit light-emitting layers may be stacked in the light-emitting display 200, thereby displaying three or more figures.

As described above, the light-emitting display 200 according to the second exemplary embodiment of the present invention can display several figures as long as a plurality of unit light-emitting layers are stacked. Thus, electrode patterns formed in the unit light-transmitting layers do not need to be intricately changed, and thus have a simple structure. Consequently, the electrode patterns can be easily designed and production cost can be reduced. In addition, the electrode patterns operate at low voltage and power consumption can be reduced.

FIG. 9 is a cross-sectional view of a light-emitting display 300 according to a third exemplary embodiment of the present invention. As illustrated in FIG. 9, at least one unit light-emitting layer 311 can be stacked on the lower surface of a base substrate 10 in the light-emitting display 300. In this case, the base substrate 10 may be formed of a transparent material. Here, electrode patterns can be more simply and easily formed and more various figures and colors can be displayed.

In addition, a light-emitting display according to an exemplary embodiment of the present invention can display a motion picture using light-emitting devices densely disposed in respective layers, can alternately display or flicker specific letters according to the arrangement of the light-emitting devices, and can display a specific logo.

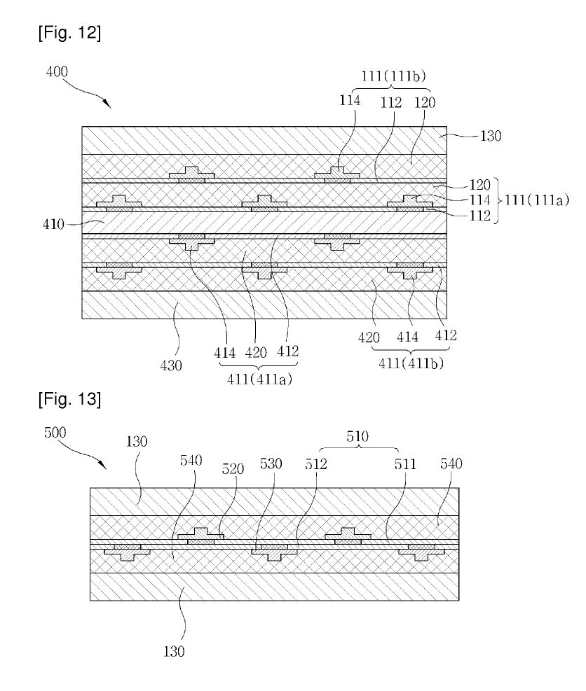

FIGS. 11 and 12 are cross-sectional views of a light-emitting display 400 according to a fourth exemplary embodiment of the present invention.

Referring to FIG. 11, the light-emitting display 400 according to the fourth exemplary embodiment of the present invention includes a base layer 410, a first unit light-emitting layer 111, and a second unit light-emitting layer 411.

The base layer 410 is interposed between the first unit light-emitting layer 111 and the second unit light-emitting layer 411 and supports the first and second unit light-emitting layers 111 and 411. Here, the base layer 410 may be formed of the same material as electrode protection layers 120 and 420 to be described below.

At least one of the first unit light-emitting layer 111 is stacked on the upper surface of the base layer 410 and emits light upward.

At least one of the second unit light-emitting layer 411 is stacked on the lower surface of the base layer 410 and emits light downward.

The first unit light-emitting layer 111 has the same structure as the unit light-emitting layer 111 of the light-emitting display 100 (see FIG. 5) according to the first exemplary embodiment of the present invention, and thus has the same reference number. The second unit light-emitting layer 411 has the same structure as the first unit light-emitting layer 111 but is formed symmetrically with the first unit light-emitting layer 111 with respect to the base layer 410.

In other words, light-emitting devices 114 included in the first unit light-emitting layer 111 are formed on the upper surface of the electrode pattern layer 112 and emit light upward, and light-emitting devices 414 included in the second unit light-emitting layer 411 are formed on the lower surface of the electrode pattern layer 412 and emit light upward or downward.

The light-emitting display 400 constituted as described above according to the fourth exemplary embodiment of the present invention can emit light downward as well as upward. The light-emitting display 400 may be installed on a display window of a store to display a figure or letters to customers outside and inside the store.

In the light-emitting display 400, the number of the first unit light-emitting layer 111 and the number of the second light-emitting layer 211 are not limited to one. As illustrated in FIG. 12, a plurality of first unit light-emitting layers 111a and 111b and a plurality of second unit light-emitting layers 211a and 211b are stacked to display various figures.

FIG. 13 is a cross-sectional view of a light-emitting display 500 according to a fifth exemplary embodiment of the present invention.

As illustrated in FIG. 13, the light-emitting display 500 according to the fifth exemplary embodiment of the present invention includes electrode pattern layers 510, first light-emitting devices 520, second light-emitting devices 530, and electrode protection layers 540. External light-transmitting plates 130 may be adhered to the surfaces of the outermost-disposed electrode protection layers 540.

A plurality of electrode patterns 511 and 512 formed in a specific pattern are formed in the upper and lower electrode pattern layers 510.

The first light-emitting devices 520 are connected with the electrode patterns 511 formed in the upper electrode pattern layer 510 and selectively emit light upward.

The second light-emitting devices 530 are connected with the electrode patterns 512 formed in the lower electrode pattern layer 510 and selectively emit light downward.

The electrode protection layers 540 are disposed to cover the upper and lower electrode pattern layers 510.

In the light-emitting display 500 constituted as described above according to the fifth exemplary embodiment of the present invention, the electrode patterns 511 and 512 are formed in the upper and lower electrode pattern layers 510, and the first light-emitting devices 520 and the second light-emitting devices 530 are disposed on the electrode patterns 511 and 512, respectively. The structure can emit light in opposite directions. In addition, since the structure does not include a base substrate, it is possible to fabricate a slim light-emitting device. In FIG. 13, the two electrode pattern layers 510 are combined with each other. However, the present invention is not limited to two electrode pattern layers, and electrode patterns may be formed on the upper and lower surfaces of one electrode pattern layer.

A light-emitting display according to an exemplary embodiment of the present invention displays various colors and figures while having simple electrode patterns. Thus, the light-emitting display operates at low voltage and reduces power consumption. Also, electrode patterns are simply designed and production cost can be reduced.

In addition, a filler layer is not formed between adhered substrates. Thus, an ultraviolet (UV) hardening step, etc., can be omitted, and the fabrication process is accelerated. Since bubbles are not generated in a space between the adhered substrates, it is possible to prevent light from being distorted and the light-emitting display has excellent transparency.

Furthermore, it is possible to form a plurality of electrode pattern layers. Thus, light sources can be disposed adjacent to each other and a motion picture can be displayed.

While the invention has been shown and described with reference to certain exemplary embodiments thereof, it will be understood by those skilled in the art that various changes in form and details may be made therein without departing from the spirit and scope of the invention as defined by the appended claims.

### INDUSTRIAL APPLICABILITY

The present invention may be industrially used in the field of illumination techniques and in its applied technical field.

1. A lighting display apparatus, comprising:
a base substrate; and
at least one unit light-emitting layer disposed on an upper surface of the base substrate, wherein the unit light-emitting layer includes:
an electrode pattern layer including a plurality of electrode patterns formed in a specific pattern;
at least one light-emitting device connected with the electrode patterns of the electrode pattern layer and selectively emitting light; and
an electrode protection layer disposed to cover the electrode pattern layer.

2. The lighting display apparatus of claim 1, wherein the electrode protection layer is formed of transparent polymer foam.

3. The lighting display apparatus of claim 2, wherein the polymer foam forming the electrode protection layer is urethane foam or acryl foam.

4. The lighting display apparatus of claim 1, further comprising:
at least one unit light-emitting layer stacked on a lower surface of the base substrate.

5. The lighting display apparatus of claim 1, capable of displaying a motion picture.

6. The lighting display apparatus of claim 1, further comprising:
an electrode protection layer formed of transparent polymer foam and interposed between the base substrate and the unit light-emitting layer.

7. The lighting display apparatus of claim 1, wherein the at least one light-emitting layer is stacked on the upper surface of the base substrate and emit light upward.

8. The lighting display apparatus of claim 7, further comprising:
an external light-transmitting plate disposed to adhere to an uppermost-disposed unit light-emitting layer.

9. A lighting display apparatus, comprising:
an electrode pattern layer having a plurality of electrode patterns formed in a specific pattern in upper and lower surfaces;
at least one first light-emitting device connected with an electrode pattern formed in the upper surface of the electrode pattern layer and selectively emitting light upward;
at least one second light-emitting device connected with an electrode pattern formed in the lower surface of the electrode pattern layer and selectively emitting light downward; and
electrode protection layers disposed to cover the upper and lower surfaces of the electrode pattern layer.

10. The lighting display apparatus of claim 9, further comprising:
an external light-transmitting plate disposed to adhere to at least one of the upper and lower surfaces of the electrode pattern layer.

11. A lighting display apparatus, comprising:
a base layer;
at least one first unit light-emitting layer stacked on an upper surface of the base layer and emitting light upward; and
at least one second unit light-emitting layer stacked on a lower surface of the base layer and emitting light downward, wherein the first and second unit light-emitting layers include:
an electrode pattern layer including a plurality of electrode patterns formed in a specific pattern;
at least one light-emitting device connected with the electrode patterns of the electrode pattern layer and selectively emitting light; and
an electrode protection layer disposed to cover the electrode pattern layer.

12. The lighting display apparatus of claim 11, further comprising:
an external light-transmitting plate disposed to adhere to an upper surface of the first unit light-emitting layer or a lower surface of the second unit light-emitting layer.

13. The lighting display apparatus of claim 1, wherein the electrode patterns are formed of at least one selected from the group of indium tin oxide (ITO), carbon nanotubes (CNTs), and a conductive polymer.

14. A method of fabricating a lighting display apparatus, comprising:
preparing a base substrate; and
stacking at least one unit light-emitting layer on an upper surface of the base substrate, wherein the unit light-emitting layer includes:
an electrode pattern layer having specific electrode patterns;
at least one light-emitting device connecting the electrode patterns; and
an electrode protection layer formed of transparent polymer foam and sealing at least the light-emitting device on the electrode pattern layer.

15. The method of claim 14, further comprising:
stacking at least one of the unit light-emitting layer on a lower surface of the base substrate.

16. The method of claim 14, further comprising:
providing an external light-emitting plate; and
adhering an external light-transmitting plate to the electrode protection layer of a finally stacked unit light-emitting layer.
